(19) United States
(12) Patent Application Publication
(10) Pub. No.: US 2011/0236697 A1
(43) Pub. Date: Sep. 29, 2011

(54) ALUMINUM FOR ULTRASONIC BONDING

(75) Inventors: Michitaka Mikami, Saga (JP); Teruo Kikuchi, Saga (JP); Shinichiro Nakashima, Saga (JP); Yuichi Hirata, Saga (JP); Masaharu Nakamura, Saga (JP); Keisuke Kimura, Saga (JP)

(73) Assignee: TANAKA DENSHI KOGYO, K.K., Tokyo (JP)

(21) Appl. No.: 12/998,861

(22) PCT Filed: Nov. 5, 2010
(86) PCT No.: PCT/JP2010/069659

§ 371 Date: Jun. 9, 2011

(30) Foreign Application Priority Data
Nov. 26, 2009 (JP) 2009-268529

(51) Int. Cl. B32B 15/04

(52) U.S. Cl. 428/457

(57) ABSTRACT

[Issues to be Solved] To provide an aluminum ribbon for ultrasonic bonding, is able to realize the high bonding strength and is able to maintain defined level of bonding strength, during several ten thousand bonding cycles.

[Means to be Solved] An aluminum ribbon for ultrasonic bonding is consisted aluminum metal or aluminum based alloy, the purity of aluminum is more than 99.99 wt %, and total amount of organic carbon non-ionic surfactant less than 500 molecular weight vaporized and adhered is 100-1,000 μg/m² on the mirror finished bright surface of aluminum ribbon.

### FIELD OF THE INVENTION

The present invention relates to an Aluminum ribbon in order to connect electrodes of semi-conductors and leads of substrates by ultrasonic bonding, in semiconductor packages and electric parts.

### STATE OF THE ART

In the manufacturing of the semiconductor devices, the bonding method using the conductive material (called “ribbon” as follows) of tape-shaped aluminum has been widely used, and a nearly rectangle of cross section is used to connect a pull-out terminal (a lead) for external made for a semiconductor package to connect an electrode (a bonding pad) set on a semiconductor chip. This bonding method is applied the method of the conductive wire of aluminum, which is put a cemented carbide tool on an electrode or ribbon of aluminum, and is joined by the load and energy of ultra-sonic wave vibration.

The effect of applying ultra-sonic wave is materialized interatomic bonding by expanding bonding area with deformation of a wire (a ribbon), braking and removing an oxidation membrane of around 1 nanometer (nm), and exposing metallic matrix of aluminum ribbon, expanding the metallic matrix with plastic flow at the interface between an aluminum ribbon and a bonding pad such as aluminum (Al) or nickel (Ni) contacted.

This practical aluminum ribbon has been manufactured by a conventional method of the ultrathin tape as follows so far.

The first method is cutting a thin plate of aluminum alloy rolled as a shape of thin plate in advance into the defined width and the length using such as a rotary cutter or a press machine, then rolling this cut thin material of aluminum alloy into a thin tape, finally forming a defined shape as an aluminum ribbon.

The second method is removing the both edges of tape material of aluminum alloy rolled into final ultrathin tape state (as for the ratio of the width for thickness around 25) by a slitter or a press machine, and forming as the shape of aluminum ribbon in defined width.

It is to be bonded by the method as same as the wire bonding using an aluminum ribbon formed thus manner onto an electrode pad, but there is somewhat difference in the bonding process.

In the wire bonding (the ball bonding), pressing a ball of wire tip and applying ultrasonic vibration onto an electrode pad heated in advance, exposing metallic matrix broken aluminum oxide membrane of the ball surface by the mechanical friction, at the same time, deforming the ball by friction heat and pressed force, expanding these new formed surfaces of so called metallic matrix, then the bonding surface is formed.

As in the wire bonding via such process, connecting a wire with an electrode pad, a bonded surface is formed with expanded new formed surfaces in the state of a crimped ball of bonding surface, so a strong bond is obtained firmly.

On the contrary, in the bonding an aluminum ribbon to an electrode pad, the bonding portion contacted to the electrode pad is a flat, moreover the boundary of electrode pad has not any deformation along the face, even if it is pressed a cemented carbide tool with ultra-sonic wave.

Therefore, it is important to strictly keep a bonding condition for all over bonding surface, but it has quite been difficult to keep these conditions, which is affected fine bumpiness and heterogeneousness within the range of possible press load and ultra-sonic energy.

For example, on the process of ultra thin tape, as machine oil had been used conventionally in rolling process, so the oil membrane, which is less than detectable limit, is even remained and distributed heterogeneously on the ribbon though washed after rolling, hence the bonding condition using aluminum ribbon for ultrasonic aluminum ribbon had been unstable. Therefore, acid washing of aluminum surface had been tried by chemical etching, as chemical etching generates microscopic etch pits on the surface of aluminum ribbon by chemical etching, so the bonding condition of ultra-sonic bonding had been unstable by these bumps.

Moreover, as aluminum ribbon which consists of aluminum alloy more than 99 wt % purity of residual aluminum and additives, is harder than conventional aluminum more than 99.99 wt % for ultrasonic bonding, so material defects such as blushing are apt to generate during metal working before rolling.

Therefore, horns and burrs generated at section and/or shear plane, are remained at aluminum ribbon edge, they catch guides and tools, they become flakes and those are stuck on the rolling mill roll surface, unevenness occurs to the surface of the aluminum ribbon.

As the results, as ultra-sonic bonding kept aluminum ribbon hardness of cold roll stage had been used to do, so large energy is required at bonding, and bonding condition becomes unstable, and there is a demerit of low bonding strength.

Above mentioned, bonding condition becomes unstable, it had been considered so far that the cause is the following mechanical reason. Namely, both surfaces of bonding pad and aluminum ribbon are not flat microscopically, and also around 1 nano meter (nm) thickness of aluminum oxide is not homogenous microscopically, as a reason, it had been considered that the position and size of contact portion to a bonding pad of aluminum ribbon does not been constant.

Therefore, various mechanical shape of aluminum ribbon had been tried to realize a stable bonding strength under stable bonding condition.

For instance, in Japanese Unexamined Patent Publication No. 2002-313851 (Patent reference No. 1), “electric current path part formed as almost plate (connecting strap)” in appearance is disclosed.

This connecting strap has bonding portion at the both edges of thin plate against an electrode pad, forming spanned arch between electrode pads, bonding with ultrasonic pressing by a bonding tool as a horn for ultrasonic pressing installed plural protuberances, but the bonding portion is flat and position and size of microscopic portion is not constant and homogenous at initial stage of bonding, it is not specific solution for unstable bonding condition of unstable bonding strength.

And, in Japanese Unexamined Patent Publication No. 2007-194270 (Patent reference No. 2), an aluminum ribbon formed plural protuberances on the aluminum ribbon surface to be connected to electrode pad is proposed. This intend as same effect as bonding wire which has a compressed ball at tip, these protuberances may deform at tip by pressing force and ultrasonic pressing, in this way, it is considered as it is easy to generate initial plastic flow, so stable bonding strength is realized compared with a bonding surface of flat ribbon by comparative small load and ultrasonic energy. However, nevertheless bonding condition is different by front and back surface, it needs to bond over ten thousand times under constant condition of automatic ultrasonic bonding at a speed ratio of several pieces for a second in the case of aluminum ribbon to bond to semiconductor device by ultrasonic bonding.

Thus, in such conventional manner of changing mechanical appearance of aluminum ribbon, though the effect may show initially, but bonding of further continuation such as over several thousand times of ultrasonic bonding, the bonding condition would not be maintained, bonding defects will occur frequently.

### THE PRECEDING TECHNICAL LITERATURE

### Patent References

[Patent reference No. 1] Japanese Unexamined Patent Publication No. 2002-313851
[Patent reference No. 2] Japanese Unexamined Patent Publication No. 2007-194270
[Patent reference No. 3] Japanese Patent No. 4212641

### DISCLOSURE OF INVENTION

### Issues To be Solved by the Present Invention

The inventors of the present invention considered that these causes were due to the phenomenon generated at contact face between a cemented carbide tool and an aluminum ribbon, from what these bonding defects generated after from several thousand cycles to several ten thousand cycles repetition of ultrasonic bonding. Then for investigation of the effect, an aluminum ribbon without surface modification was ultrasonic-bonded over 20 thousand cycles in automatic mode using a cemented carbide tool over several thousand cycles of practical life of ultrasonic bonding. During the experiment, change of contact face of cemented carbide tool to aluminum ribbon was investigated. After 20 thousand cycles, the contact face became like an archipelago of aluminum powder (accumulated state of metallic aluminum powder or aluminum oxide powder on contact face of a cemented carbide tool). The phenomenon distributed aggregates of “metallic aluminum powder or oxide powder” at contact face to aluminum ribbon on the cemented carbide tool is considered as the next following process.

At first, in ultrasonic bonding, the boundary face between aluminum ribbon and bonding pad or lead frame is heated up by friction, then generating the new face, the boundary face of bonding pad or lead frame is bonded. At the same time, the boundary face of cemented carbide tool and aluminum ribbon also are heated up by friction, hence the new face is generated at boundary face of aluminum ribbon. From the side of boundary face contacted to tool of aluminum ribbon, metallic as-is aluminum (Al) or aluminum oxide are adhered to the contact face of the cemented carbide tool. Once aluminum oxide is adhered, aluminum and aluminum oxide are adhered preferentially, then, aluminum (Al) becomes to be cohesion state at following bonding cycles. Consequently, such as aluminum oxide islands are formed on the contact face of the cemented carbide tool gathering these aluminum oxides adhered finally. Many aluminum oxide islands are generated on the contact face of cemented carbide tool, so archipelago of aluminum oxide powder is formed as the results.

Aluminum oxide layer formed such archipelago makes contact state with cemented carbide tool and aluminum ribbon heterogenous, adding ultrasonic energy, generating heat, and going up temperature, promoting more accumulation of oxide layer, then ultrasonic vibration energy transfer from the cemented carbide tool to interface of aluminum ribbon becomes heterogenous, finally bad influence is brought to the joining process.

Therefore, bonding strength of aluminum ribbon has variance with forming such as archipelago.

So on aluminum ribbon contact surface of cemented carbide tool at ultrasonic bonding using an aluminum ribbon, not adhering aluminum (Al), or, even if adhering, when it's possible to make aluminum (Al) detached from contact surface of a cemented carbide tool, even if it's joined tens of thousands of times, it might be possible to join homogeneously over a surface in a joint surface each time.

Therefore, in this present invention, providing an aluminum ribbon, which is able to realize more stable bonding strength, and which is not formed such aluminum or aluminum oxide archipelago after repeated ultrasonic bonding, homogenous transforming of ultrasonic vibration energy from a cemented carbide tool to interface of aluminum ribbon, homogenous temperature distribution, maintaining homogenous bonding condition to whole bonding portion, is the subject.

### Means to be Solved the Subject

As means to be solved the above mentioned subject, the aluminum ribbon for ultrasonic bonding of the present invention comprising: evaporated/dry surfactant, which molecular weight is less than 500, and the general organic carbon amount of non-ionic surfactant is 100-1000 μg/m² on the mirror finished aluminum ribbon.

The inventors of this present invention researched conditions of surface modification factors affected to the bonding results on ultrasonic bonding, considering the above mentioned subject.

The relationship of ultrasonic bonding characteristics of aluminum ribbon were investigated about lubricant ingredients described in Patent reference No. 1. Namely, Paraffinic petrolatum, Polypropylene glycol, Fatty acid soap and Palm oil as lubricant ingredients were used. In the case of aluminum wire, new surface is enlarged and becomes a new bond at ultrasonic bonding, but, in the case of aluminum ribbon, it is not expected such phenomenon, so it had not been able to acquire high and stable bonding strength as after several thousands times of bonding cycle, accumulation of contamination on the side of cemented carbon tool contacted to aluminum ribbon as generated variance of bonding strength.

15% solution of Perfluoro-tributyl-amine (AGC “CTL-816AP”) with mix solution of Perfluoro-alcohol and pure water as solvent described in Patent reference No. 2 was used, but after several hundreds times of bonding cycle, variance of bonding strength was generated soon, it was not able to acquire high and stable bonding strength.

Moreover, the inventors had tried to arrange conditioning about crystal grain size and surface roughness to improve bonding characteristics, of aluminum ribbon described in Patent reference No. 3, in this case also, after several thousands times of bonding cycle, variance of bonding strength was generated, it was not able to acquire high and stable bonding strength.

In these examples, lubricant ingredients on the contrary have adverse effect because of lubricant ingredients themselves become contamination on the cemented carbide tool. Additionally, on bonding wire, about forming covered membrane of lubricant ingredients for conditioning of the surface, by mean thickness 0.5 μm-50 angstroms of it on gold or gold alloy bonding wire, to prevent adhesive phenomenon of wire winded to multi-layer around a spool each other, and in Japanese Unexamined Patent Application Publication No. 2002-241782, it is disclosed that organic matter does not accumulate in the capillary at bonding if using water solution of non-ionic surfactant for high purity gold wire drawing lubricant, which has 10-20 HLB value and 350-20,000 molecular weight.

Moreover, in Japanese Unexamined Patent Application Publication No. 2008-172009, it is described that unwinding characteristics is maintained and wire adhesion each other is able to be prevented without transferring of organic matter to clumper or capillary by forming mono molecular adsorbed layer of gold non-ionic surfactant.

However, these surface-active agent films are concerning lubrication improvement or prevention of such surfactant accumulation to a capillary at gold wire bonding, are not concerning adhesive phenomenon of aluminum or aluminum oxide to a cemented carbide tool, on aluminum ribbon mentioned before.

Therefore, the inventors of the present invention had tried to attain homogenization of contact condition by intervening of an ultra thin membrane at both interfaces, considered that adhesive phenomenon of aluminum oxide formed at the above mentioned aluminum ribbon surface is depending on contact condition with a cemented carbide tool and these ribbon surfaces. As non-ionic surfactant has capability of forming strong membrane as an ultra thin membrane, so condition had been researched to confirm effect (mentioned before) about these non-ionic surfactants for the means of surface conditioning of aluminum ribbon.

As the results, it was found that these subjects can be attained under condition of evaporated/dry surfactant, which molecular weight is less than 500, if the general organic carbon amount of non-ionic surfactant is 100-1000 μg/m² on the mirror finished aluminum ribbon.

Aluminum ribbon with mirror finished brightness and flat rolled using for ultrasonic bonding of this present invention is more than 99.99 wt % the purity and less than 0.01 wt % impurity of aluminum and/or the matrix of aluminum alloy, but this aluminum ribbon is apt to generate the phenomenon mentioned before at ultrasonic bonding.

The clear whole mechanism of it has not been elucidated so far, but it can be thought mostly as follows.

First of all, at the interface of a cemented carbide tool and aluminum ribbon, when surfactant is more than defined thickness, by its lubrication characteristics, aluminum ribbon dose not become to follow sufficiently, so surfactant generates friction and heat on the contrary by slip with ultrasonic vibration at contact face between a cemented carbide tool and aluminum ribbon.

On the other hand, because high purity aluminum has a low melting point and also it is soft, so the surface of aluminum is torn off by heat by ultrasonic vibration and ultrasonic vibration itself, finally the residual of it adheres onto a cemented carbide tool with its oxidation. Once this phenomenon occurs, the influence becomes greater and enlarged aluminum and aluminum oxide accumulation, after all it grows and shows such archipelago pattern mentioned before. By intervene of these accumulations, transfer of ultrasonic energy to aluminum ribbon from a cemented carbide tool becomes heterogeneous and also insufficient, and bonding condition of a whole bonding surface becomes heterogeneous.

On the contrary, it becomes able to do ultrasonic bonding over ten thousands cycles without generating abnormal heat and also without generating any accumulation layer under initial condition, if membrane condition meets to the above mentioned non-ionic surfactant of the present invention, because it can be followed ultrasonic vibration from a cemented carbide tool to the ribbon.

Moreover, non-ionic surfactant mars bondability at opposite side of bonding surface to contact face of a cemented carbide tool of aluminum ribbon intervening as a thick membrane. At the interface between aluminum ribbon and electrode, aluminum ribbon is bonded by mechanical contact and heat by friction with ultrasonic vibration, as it is different from the interface of a cemented carbide tool, and electrode is in a state of fixation, moreover as there is no difference between both materials to be bonded comparing with materials between a cemented carbide tool and aluminum, so aluminum is bonded with emitting ultrasonic energy by friction at mutual interface without existence of lubricant surfactant.

On the other hand, surfactant is preferable to be less, because it is non-metallic impurity for an aluminum ribbon. Therefore, non-ionic surfactant with low critical micelle concentration was used in order to keep constant condition of the surface of flat rolled aluminum ribbon. By the way, the critical micelle concentration varies significantly if adding alcohol or salt, even though in the case of water solution solvent.

The non-ionic surfactant of the present invention is preferable to be a low molecular weight type surfactant, which molecular weight is less than 500. It intends that aluminum does not glue on contact face of aluminum ribbon at a cemented carbon tool at ultrasonic bonding from aspect of the mechanism mentioned before.

The non-ionic surfactant is preferable to have a low resolution temperature and solubility into solvent. In general, the solvent is pure water. If the non-ionic surfactant is not soluble into pure water, it is possible to use mixed solvent with alcohol and pure water. As alcohol has alcohol-radical, so aluminum hydrate (AlO(OH)) would not be formed by water in the Air on the surface of aluminum ribbon and water from wire drawing, moreover alcohol-radical has possibility of forming aluminum and alco-oxid-compounds.

Moreover, it is possible to disperse non-ionic surfactant homogenously using with anionic surfactant. There is ammonium dodecylbenzenesulphonate as an anionic surfactant, and it is in the market as a mixture with non-ionic surfactant and anionic surfactant conventionally.

Non-ionic surfactant of the present invention is not recommended if it is macromolecule surfactant. If non-ionic surfactant is less than critical micelle concentration, and it is a macromolecule surfactant, it is relatively stable at high temperature as a surfactant. Therefore, macromolecule surfactant does not decompose at ultrasonic bonding, so carbon becomes to be carbonized and remains on the surface of cemented carbon tool, since it is in danger that it makes next ultrasonic bonding unstable. It's to form homogenous membrane on the mirror finished surface of aluminum ribbon to vaporize and dry surfactant on aluminum ribbon.

Moreover, on the non-ionic surfactant of the present invention, total organic carbon amount should be 30-1000 μg/m², it is intended that nano-order thickness of membrane in average should be formed on the mirror finished aluminum ribbon. Since the nano-order thickness membrane in average is difficult to measure accurately, because it is too thin, so it is specified by the total organic carbon. The total organic carbon amount is ultra small amount such as 30-1000 μg/m², because it is possible in order to avoid carbon contamination on the surface of cemented carbide tool at ultrasonic bonding.

As amide group of non-ionic surfactants of the present invention, there are alkanolamide, which is alcohol type of non-ionic surfactant, knoll alkaline alkane amide and fatty acid alkanolamide. The alcohol type of non-ionic surfactant is preferable as alkanolamide type of non-ionic surfactant. Since non-ionic surfactant is easy to be resolved ingredient from the surface of cemented carbide tool at ultrasonic bonding. Fatty acid alkanolamide has a substitution structure of R—CO— and —CH₂CH₂OH by hydrogen as centered N, and it is shown as a chemical equation of R—CON(CH₂CH₂OH)₂.

### EFFECTS OF THE PRESENT INVENTION

Stable bonding strength is realized under repeated ultrasonic bonding condition, aluminum oxide contamination is not formed at the surface of cemented carbide tool at ultrasonic bonding by the homogenous distributed membrane of the above mentioned specific non-ionic surfactant vapored and adhered. Moreover, loop forming characteristics becomes more stable, as slip characteristics of aluminum ribbon through the cemented carbide tool is improved, surface of aluminum ribbon is changed into lipophilicity, avoiding water inclusion in the air. And, as the membrane of non-ionic surfactant is extremely thin, so carbon contamination at the surface of cemented carbide tool is able to be avoided even after several thousands cycle of ultrasonic bonding, mean while stable bonding condition is maintained without variance of bonding strength at ultrasonic bonding.

### DESCRIPTION OF THE MOST PREFERRED EMBODIMENT

It was found that the less carbon number of non-ionic surfactant is the more less carbon residual at ultrasonic bonding from 20 thousand cycles of ultrasonic bonding test. Since non-ionic surfactant solution is so dilute, so it is difficult to measure the concentration. For example, when measuring surface tension of non-ionic surfactant solution by ring method using a Dyunui surface tension tester (from Ito-seisakusyo Co. Ltd.), the concentration of it is 0.001%, the measured value is indicated as same as solution without non-ionic surfactant.

On the other hand, on aluminum ribbon, it is possible to use the conventional one. It is preferable that if aluminum ribbon is better mirror finished, as the surface area with oxide forming is decreased, the criterion of the surface roughness R_{z} is less than 2 μm. As it is used the range of 10-120 Hz high frequency at ultrasonic bonding for aluminum ribbon, if the range of average crystal grain size of aluminum ribbon is within 5-200 μm and the surface roughness R_{z} is less than 2 μm, so the stable bonding strength can be attained, because Al alloy of more than 99 wt % is soft and micro-void can be avoided. The more preferable surface roughness R_{z} is less than 1.6 μm.

Especially, stable bonding strength is possible to be acquired by conditioning crystal grain size of aluminum ribbon, with small variance of bonding strength. Moreover, micro-void at bonding boundary is avoided by using mirror finished aluminum ribbon, and stable bonding area is acquired, moreover stable ultrasonic bonding is attained even in the case of narrow pitch between pads.

The heat-treatment process of vaporizing and adhering is dry up in line just after dipping an aluminum ribbon in the defined solution. The general heat-treatment temperature is 100-450 degree centigrade, and line speed of aluminum ribbon is 10-100 m/min in general. The heat-treatment temperature is preferable to be higher than bonding temperature of aluminum ribbon at ultrasonic bonding. The carbon contamination, which adhered at the surface of cemented carbide tool and resolved non-ionic surfactant, should be avoided at ultrasonic bonding. By the way, the atmosphere of heat-treatment is sufficient in the Air, since ultrasonic bonding of aluminum ribbon is done in the Air.

In general, the thickness of aluminum ribbon is preferable to be 10 μm-1 mm from the aspect of optimized valance between applied ultrasonic power and applied load. The preferable ratio of width to thickness of aluminum ribbon is the range of 7-16.

It is preferable that if aluminum ribbon is better mirror finished, as the surface area with oxide forming is decreased, the criterion of the surface roughness R_{z} is less than 2 μm. As it is used the range of 10-120 Hz high frequency at ultrasonic bonding for aluminum ribbon, if the range of average crystal grain size of aluminum ribbon is within 5-200 μm and the surface roughness R_{z} is less than 2 μm, so the stable bonding strength can be attained, because Al alloy of more than 99 wt % is soft and micro-void can be avoided. The more preferable surface roughness R_{z} is less than 1.6 μm.

On the other hand, the composition of aluminum ribbon of the present invention is comprising of pure metal of aluminum which is more than 99.99 wt % purity and impurity less than 0.01 wt % or aluminum based alloy which is pure metal of aluminum more than 99.9 wt % purity and additive less than 0.1 wt % purity. The acceptable elements as additives are such as Ni, Si, Mg, Cu, B, In, Li, Be, Ca, Sr, Y, La, Ce, Nd, Bi, Ni, Si, Mg and Cu are effective elements for crystal grain size conditioning.

There is inevitable impurity of less than 0.01 wt % as the residual aluminum in the aluminum alloy more than 99.99 wt % purity. As the influence of inevitable elements is unknown, so such inevitable elements are preferable to be less. In the case of aluminum more than 99.99 wt % purity, there is no problem on vaporizing and adhering under condition of heat-treatment temperature of 200-450 degree centigrade and line speed of 10-100 m/min without depending on combination and amount of additive elements. It is needless to say that if starting alloy of aluminum is more than 99.999 wt % purity is more preferable.

It is possible to acquire high and stable bonding strength if using aluminum alloy as aluminum ribbon, which is additive element of Ni 10-300 wt ppm and residual aluminum is more than 99.99 wt % purity.

Preferable embodiment of aluminum alloy using for aluminum ribbon is as follows. The additive elements are comprised of 5-700 ppm as total at least one element among Ni, Si, Mg and Cu.

The 10-300 ppm of Ni as additive element is especially preferable.

It is preferable that residual aluminum is more than 99.99 wt % purity of Al and less than 0.01 wt % of impurity, and also more than 99.999 wt % purity of Al and less than 0.001 wt % of impurity.

Especially, it is preferable that aluminum alloy which is more than 99.99 wt % purity of Al alloy including 10-300 wt ppm of Ni as additive and residual Al is more than 99.99 wt % purity, more preferable residual Al is more than 99.999 wt % purity from easy conditioning of crystal grain size of aluminum ribbon.

About mirror finishing of the surface of aluminum ribbon, 1 rolling or 2 rollings are preferable from wire to ultra thin tape. Phenomena of unstable bonding strength had been observed when aluminum ribbon which has the number of rolling times more than 3 at ultrasonic bonding. Variance of bonding strength at bonding has no relationship to presence or absence of non-ionic surfactant, it is considered that as the results rolled stracture is put through furthermore, strain of inner metallic stracture becomes large, and portion, which does not enlarge crystal grain size, is generated by heat-treatment after rolling, so crystal grain size becomes heterogenous. Therefore, the best result was acquired in the case of one pass rolling with less variance of bonding strength. Effect of aluminum ribbon in the Patent reference No. 3 is also maintained in the present invention.

By the way, though new active surface is generated at the surface of aluminum ribbon by one pass rolling, the active surface is less, and oxidized aluminum membrane of around 1 nm thickness is formed soon after rolling by oxidization by oxygen of the Air. These oxidized aluminum membranes do not adhere each other, it is possible to be a multi-layers of aluminum ribbon scroll. The task of unmanned ultrasonic bonding is possible to develop continuously, if the bonding strength of multi-layers aluminum ribbon scroll is stable.

### Examples

Examples of the present invention are explained here in after.

The alloy composition shown in Table 1 (aluminum as starting material is more than 99.999 wt % purity Al) was used. The same results got from more than 99.99 wt % purity of Al. Defined wire diameter of bonding wire was used as starting material. Examples 1-20 and Controls 1-5 of aluminum ribbon were prepared shown in Table 1.

Then these aluminum ribbon was rolled by one pass heated rolling using a rolling mill (is not illustrated). The surface roughness R_{z} was 0.5 μm. The average crystal grain size was 10 μm. The thickness was 120 μm. The aspect ratio namely, width/thickness was 11. Then these aluminum ribbons were washed twice by hot pure water, which temperature was 80 degree centigrade. Afterwards, dipping the defined aluminum ribbon for 0.8 sec at room temperature in the Cleanthrough-LC-841 (from Kao Chemicals Inc.) of non-ionic surfactant diluted solution by pure water to 5,000 times (Solution A) at line speed of 80 m/min, then it was passed through a heat-treatment furnace at 320 degree centigrade at line speed of 80 m/min for 0.4 sec continuously, non-ionic surfactant was evaporated and adhered to the aluminum ribbon.

In the same way, after dipping aluminum ribbon in the EleaseK1000 (from ASAHI KASEI CHEMICALS CORPORATION) diluted solution by pure water to 10,000 times (Solution B) at 50 degree centigrade for 0.6 sec, it was pass through a heat-treatment furnace at 400 degree centigrade for 0.4 sec at line speed of 100 m/min continuously, non-ionic surfactant was evaporated and adhered to the aluminum ribbon.

In the same way, after dipping aluminum ribbon in the SunwashFM-550 (from LION CORPORATION) diluted solution by pure water to 50,000 times (Solution C) at room temperature for 0.2 sec, it was pass through a heat-treatment furnace at 250 degree centigrade for 0.6 sec at line speed of 100 m/min continuously, non-ionic surfactant was evaporated and adhered to the aluminum ribbon.

In the same way, after dipping aluminum ribbon in the SunwashFM-200 (Principal component is a mixture of non-ionic surfactant and anion surfactant) (from LION CORPORATION) diluted solution by pure water to 3,000 times (Solution D) at room temperature for 1.0 sec, it was pass through a heat-treatment furnace at 250 degree centigrade for 0.6 sec at line speed of 80 m/min continuously, non-ionic surfactant was evaporated and adhered to the aluminum ribbon.

Examples 1-20 of the present invention and Controls 1-5 obtained in this way were ultrasonic-bonded around 20 thousand times to an Al plate (Thickness is 5 mm), which is more than 99.99 wt % purity, continuously.

The condition of ultrasonic bonding is as follows:

The loop length of aluminum ribbon shown in Table 1 is 50 mm. The loop height is 30 mm. The larger sliding resistance condition, which is affected from ribbon pass and tool, was set than conventional one.

Aluminum ribbons shown in Table 1 were ultrasonic-bonded to aluminum plate (Thickness is 5 mm) of more than 99.99 wt % purity Al by the full automatic ribbon-bonder 3600R from Orthodyne Electronics Co.

The condition of bonding was 80 kHz at frequency, and was adjusted to be that the collapse width is 1.05 times of ribbon width.

The cemented carbide tools and bonding guides corresponding to the ribbon size provided by Orthodyne Electronics Co. were used.

The bonding strength was measured as shear strength from the side of bonding portion using by the universal bond-tester PC400 from Nordson Dage. As a reliability test, the bonded-substrates after exposure at 150 degree centigrade for 1,000 hours were measured as shear-strength.

The divided value of shear-strength after reliability test by shear-strength before reliability test was defined as “strength-ratio after reliability test” and evaluation was done using the value.

On the initial shear-strength, the first bond was 4,000 gf and the second bond was 5,000 gf (where the target is 4,500 gf). The results were satisfied against the value of general shear-strength (3,000-6,000 gf), although it is depending on the size of electronic pad bonded by bonding. On the case of repeated bonding till 20 thousand times, evaluation was done by “the strength-ratio after reliability test”.

The variance of bonding strength till 20 thousand times was divided as following four stages and evaluated:

Namely, Measured Value A: the average value from the initial 1 to 40 cycles, Measured Value B: the average value from 5,001 to 5,040 cycles, Measured Value C: the average value from 10,001 to 10,040 cycles, Measured Value D: the average value from 15,001 to 15,040 cycles, and Measured Value E: the average value from 20,001 to 20,040 cycles.

By the way, measurement of total amount of Organic carbon of non-ionic surfactant on the surface of aluminum ribbon was done as follows:

Weighing 10,000 m of aluminum ribbon: boiling in the water solution of adding 200 g of 0.1 N—NaOH for 30 min in a water bath: after cooling off: shaking slightly in the water solution of adding 2.5 ml of 8N-HCl: babbling with high purity Air for 15 min. This was supplied to organic carbon analyzer TOC-5000 from Shimadzu Ltd., and the concentration of organic carbon was measured. From this value, the total amount of organic carbon was calculated. The total amount of organic carbon of the surface of aluminum ribbon was defined as the divided value of it by surface area of aluminum ribbon.

The judgement was done based on “the strength-ratio after reliability test”. Results are shown for more than 0.9 of “the strength-ratio after reliability test” is shown as “Excellent”, more than 0.7 to less than 0.9 of it is shown as “Fair”, and less than 0.7 of it is shown as “Bad”.

The judgement results from the Measured Value B to the Measured Value D are shown in Table 1. The Measured Value A is a reference value. On the Measured Value D for all Examples, all values of “the strength-ratio after reliability test” were more than 0.9 to Measured Value A and they are uniformly OK, on the contrary, the value of Controls were NG. Therefore, these values are not shown in the table.

TABLE 1

| | | | | | | | | Total organic | | | | |
|---|---|---|---|---|---|---|---|---|---|---|---|---|
| | | Composition (Value is wt ppm) | | | | | Non ionic | carbon amount | Measured Value | | | |
| | | Al | Ni | Mg | Si | Cu | surfactant | (μg/m²⁾ | B | C | D | Judgment |
| Examples | 1 | Residual | 20 | | | | Solution A | 502 | Excellent | Excellent | Excellent | OK |
| | 2 | Residual | 40 | | | | Solution B | 252 | Excellent | Excellent | Excellent | OK |
| | 3 | Residual | | 40 | | | Solution C | 413 | Excellent | Excellent | Excellent | OK |
| | 4 | Residual | | | 40 | | Solution D | 691 | Excellent | Excellent | Excellent | OK |
| | 5 | Residual | | | | 40 | Solution A | 491 | Excellent | Excellent | Excellent | OK |
| | 6 | Residual | 80 | | | | Solution B | 248 | Excellent | Excellent | Excellent | OK |
| | 7 | Residual | | 80 | 120 | | Solution C | 399 | Excellent | Excellent | Excellent | OK |
| | 8 | Residual | 160 | | | 80 | Solution D | 677 | Excellent | Excellent | Excellent | OK |
| | 9 | Residual | 240 | | | | Solution A | 470 | Excellent | Excellent | Excellent | OK |
| | 10 | Residual | | 120 | 120 | 120 | Solution B | 239 | Excellent | Excellent | Excellent | OK |
| | 11 | Residual | | 480 | | | Solution C | 394 | Excellent | Excellent | Excellent | OK |
| | 12 | Residual | | | | 480 | Solution D | 659 | Excellent | Excellent | Excellent | OK |
| | 13 | Residual | | | 480 | | Solution A | 477 | Excellent | Excellent | Excellent | OK |
| | 14 | Residual | 480 | | | | Solution B | 245 | Excellent | Excellent | Excellent | OK |
| | 15 | Residual | 240 | | 20 | | Solution C | 405 | Excellent | Excellent | Excellent | OK |
| | 16 | Residual | | 240 | | 20 | Solution D | 664 | Excellent | Excellent | Excellent | OK |
| | 17 | Residual | 80 | | | 480 | Solution A | 466 | Excellent | Excellent | Excellent | OK |
| | 18 | Residual | 120 | 80 | 240 | | Solution B | 230 | Excellent | Excellent | Excellent | OK |
| | 19 | Residual | 80 | 240 | | 120 | Solution C | 388 | Excellent | Excellent | Excellent | OK |
| | 20 | Residual | 120 | 120 | 120 | 120 | Solution D | 651 | Excellent | Excellent | Excellent | OK |
| Controls | 1 | Residual | 500 | | | | Nothing | 23 | Fair | Fair | Bad | NG |
| | 2 | Residual | | 1000 | | | Solution A | 55,213 | Bad | Bad | Bad | NG |
| | | | | | | | (Concentration is | | | | | |
| | | | | | | | 103 times) | | | | | |
| | 3 | Residual | | | 500 | | Solution B | 25,113 | Fair | Bad | Bad | NG |
| | | | | | | | (Concentration is | | | | | |
| | | | | | | | 103 times) | | | | | |
| | 4 | Residual | | 500 | | 500 | Solution C | 39,734 | Bad | Bad | Bad | NG |
| | | | | | | | (Concentration is | | | | | |
| | | | | | | | 103 times) | | | | | |
| | 5 | Residual | 250 | 250 | 250 | 250 | Solution D | 66,341 | Bad | Bad | Bad | NG |
| | | | | | | | (Concentration is | | | | | |
| | | | | | | | 103 times) | | | | | |

The aluminum ribbon of Examples and Controls has a contact surface like located purl bonding wires with equal interval at contact surface to electrode. The bonding mechanism is similar to the so far proven bonding mechanism of bonding wire. By the way, the state of bonding portion dissolved and separated aluminum ribbon after strength ratio test of reliability was observed. The bonding point had homogeneous bonding root for all bonding surface to all Examples from 1 to 20. The bonding root of bonding point of Controls from 1 to 5 had homogeneous bonding root for Measurement Value A, but Measurement Value C, D and E were not bonded, and Measurement Value B of Control 4 and 5 were only partially bonded.

### POSSIBILITY OF USE IN INDUSTRY

An aluminum ribbon for ultrasonic bonding of this present invention raises the product reliability, it is possible to decrease in cost, and also because it is possible to maintain the high joining strength and reliability in more than 20,000 times of bonding, and stable bonding can do for an extended period, and this aluminum ribbon is very useful for industry.

What is claimed is:

1. An aluminum ribbon for ultrasonic bonding comprising: the material is an aluminum metal or aluminum based alloy, which are more than 99.99 wt % purity of Al, or aluminum based alloy with this aluminum pure metal of more than 99.9 wt % and less than 0.1 wt % of additive elements, and the surface is mirror-finished and the roughness R_{z} is less than 2 μm, and non-ionic surfactant is vaporized and adhered on the mirror finished surface and the total amount of organic carbon of said aluminum ribbon is featured at 30-1,000 μg/m² on the mirror finished surface.

2. An aluminum ribbon for ultrasonic bonding comprising: the featured vaporizing and adhering is done at higher temperature than temperature of ultrasonic bonding to claim 1.

3. An aluminum ribbon for ultrasonic bonding comprising: the vaporized and adhered non-ionic surfactant is featured from the non-ionic surfactant dissolved solution of alcohol and pure water to claim 1.

4. An Aluminum ribbon for ultrasonic bonding comprising: total amount of additive elements of the alloy is featured as 5-700 wt ppm of total at least one element among Ni, Si, Mg and Cu to claim 1.

5. An aluminum ribbon for ultrasonic bonding comprising: non-ionic surfactant is featured combination use with anion surfactant to claim 1.

6. An aluminum ribbon for ultrasonic bonding comprising: non-ionic surfactant is featured amide group of non-ionic surfactants to claim 1.
